(19) United States
(12) Patent Application Publication
(10) Pub. No.: US 2006/0210348 A1
(43) Pub. Date: Sep. 21, 2006

(54) Writing instruments

(76) Inventor: Liang Wang, San Gabriel, CA (US)

Correspondence Address: LIANG WANG, 8259 E. LIVE OAK ST., SAN GABRIEL, CA, 91776, US

(21) Appl. No.: 11/088,007

(22) Filed: Mar. 18, 2005

(51) Int. Cl. A46B 11/00; B43K 5/00

(52) U.S. Cl. 401/46; 401/45

(57) ABSTRACT

A writing instrument comprises: a writing tip for spreading writing fluid on surface of written media, a first reservoir chamber having a fluid outlet for supplying the writing tip with writhing fluid, a connecting sleeve for connecting the writing tip and the first reservoir chamber, in characterized that said instrument further comprises at least one additional reservoir chamber inside or outside of the first reservoir chamber, wherein each additional reservoir chamber comprises a fluid outlet, and wherein, with relative rotation between the fluid outlet of the at least one additional reservoir chamber and the connecting sleeve, the writing fluid of the at least one additional reservoir chamber is conducted to the writing tip via the fluid outlet to supply the writing tip with the writing fluid continually. The chambers are switched by way of relative rotation to supply the writing fluid continually. The writing instrument has a reasonable structure and low cost and eliminates the leakage due to the pressure and attractive force generated by internal shock or longitudinal movement of the reservoir chambers in the prior art. The writing instrument of the present invention has the advantages of simple structure, low cast and long working life.

### FIELD OF THE INVENTION

The present invention relates to writing instruments. In particular, the invention relates to felt tip pens, fiber tip pens, ball pens, pens and any other writing instruments.

### SUMMARY OF THE PRIOR ART

At present, there are a variety of different writing instruments suffering the following disadvantages: 1. The volume for storing the writing fluid is too small and the frequency for refilling the writing fluid or changing refills is very high; 2. ink leakage can occur if the writing instruments carry the writing fluid more than it can bear. The current writing instruments have low leak resistance and small volume for the writing fluid; and 3, for the expendable writing instruments, it is very quick to be used up and thrown away even if they look new. Such writing instruments have low use rate.

There are some improvements developed to overcome the above problems. For examples, WO93/05966 discloses a marking instrument, and CN1086173A relates a writing instrument. Both of them disclose solutions of large and small reservoir chambers for resolve the problem of low volume for writing fluid. In those solutions, the reservoir chambers are divided into large and small reservoir chambers by a diaphragm member, and writing tip is retractable so as to open the diaphragm member for allowing the writing fluid be supplied from the larger reservoir chamber to the smaller reservoir chamber. The advantage thereof is to increase the volume of the writing instrument for the writing fluid, but it has been found that the writing fluid can continue to flow or ooze to the marking tip during the writing when or after the writing fluid is supplied from the larger reservoir chamber to the smaller reservoir chamber. One of the reasons is that the writing fluid is supplied from the larger reservoir chamber to the smaller reservoir chamber by way of opening a valve with longitudinal movement of a moveable member, resulting in generating pressure in the reservoir chambers causing the writing fluid continually flowing and oozing.

WO96/14998 relates to an improvement. WO96/14998 discloses a marking instrument similar to WO93/05966 and CN1086173A. It provides a small reservoir chamber being annular resiliently deformable member to draw fluid through the supply channel from the tip during forward displacement of the tip by increasing the volume of the chamber. However, it is impossible to draw the writing fluid from the tip if more writing fluid flows and ooze from the tip or if it draws air rather than the writing fluid from the tip. For the writing instruments having ball tip, it is impossible to draw the fluid leaked or pressed out of the instruments because they are closed types. Therefore, leakage suntill occurs.

### SUMMARY OF THE INVENTION

The object of the present invention is to provide a writing instrument increasing volume for writing fluid and effectively preventing and avoiding leakage so as to overcome the problems existing in the prior art.

The invention provides a writing instrument, the writing instrument comprising: a writing tip for spreading writing fluid on surface of written media, a first reservoir chamber having a fluid outlet for supplying the writing tip with writhing fluid, a connecting sleeve for connecting the writing tip and the first reservoir chamber, in characterized that said instrument further comprises at least one additional reservoir chamber in the inside or outside of the first reservoir chamber, wherein each additional reservoir chamber comprises a fluid outlet, and wherein, with relative rotation between the fluid outlet of the at least one additional reservoir chamber and the connecting sleeve, the writing fluid of the at least one additional reservoir chamber is conducted to the writing tip via the fluid outlet to supply the writing tip with the writing fluid continually.

The at least one additional reservoir chamber outside of the first reservoir chamber and the first reservoir chamber are in transverse arrangement in (or along) the direction of the length of the writing instrument, and the connecting sleeve comprises an inlet, and wherein the first reservoir chamber and the at least one additional reservoir chamber are rotated, and with relative rotation between the fluid outlet of the at least one additional reservoir chamber and the connecting sleeve, the fluid outlet of the at least one additional reservoir chamber communicates with the inlet of the connecting sleeve in turn such that the writing fluid of the at least one additional reservoir chamber is conducted to the writing tip via the fluid outlet and the inlet of the connecting sleeve to supply writing fluid to the writing tip continually.

The at least one additional reservoir chamber outside of the first reservoir chamber and the first reservoir chamber are in longitudinal arrangement in the direction of the length of the writing instrument, the at least one additional reservoir chamber is located above the first reservoir chamber, and the first reservoir chamber or the first and at least one additional reservoir chambers comprise fluid inlets at the top portions thereof, and wherein the chamber casing or the bottom portion of the at least one additional reservoir chamber is rotated, and with relative rotation between the fluid outlet of the at least one additional reservoir chamber and the connecting sleeve, the fluid outlet of the at least one additional reservoir chamber communicates with the fluid inlet of the first reservoir chamber in turn such that writing fluid of the at least one additional reservoir chamber flows into the first reservoir chamber via the fluid inlet of the first reservoir chamber in turn to supply the writing fluid to the writing tip continually.

The writing instrument further comprises a center shaft disposed in the at least one additional reservoir chamber and at the connection between the bottom portion and the top portion of the at least one additional reservoir chamber to allow the bottom portion of the at least one additional reservoir chamber to rotate such that the fluid outlet of the at least one additional reservoir chamber communicates with the fluid inlet of the first reservoir chamber in turn.

The at least one additional reservoir chamber inside or outside the first reservoir chamber is disposed surrounding the first reservoir chamber, and the connecting sleeve comprises at least two inlets, one of them communicating with the first reservoir chamber, and wherein the first reservoir chamber and the at least one additional reservoir chamber rotate, and with relative rotation between the fluid outlet of the at least one additional reservoir chamber and the connecting sleeve, the fluid outlet of the at least one additional reservoir chamber communicates with another inlet of at least two inlets of the connecting sleeve in turn such that writing fluid of the at least one additional reservoir chamber is conducted to the writing tip via the fluid outlet and the another inlet of the connecting sleeve to supply the writing fluid to the writing tip continually.

The writing instrument further comprises a seal washer disposed between the first and at least one additional reservoir chambers and the connecting sleeve.

The writing instrument further comprises a fiber fluid core arranged in the first reservoir chamber and/or the at least one additional reservoir chamber to allow the writing fluid of the first reservoir chamber and/or the at least one additional reservoir chamber to be absorbed in the fiber fluid core, wherein the fiber fluid core communicates with the writing tip via the fluid outlets of the first reservoir chamber and/or the at least one additional reservoir chamber.

The writing tip is a conventional ball tip, pen tip, or a conducting fluid core for adsorbing writing fluid and writing, or the combinations thereof.

The first reservoir chamber and/or the at least one additional reservoir chamber comprises a stopper or stopping channel at the connection connecting with the connecting sleeve to fit with a stopping channel or stopper disposed on the connecting sleeve for limiting relative rotation between the first and at least one additional reservoir chambers and the connecting sleeve to communicate the fluid outlet of the at least one additional reservoir chamber with the inlet of the connecting sleeve in turn such that the writing fluid of the at least one additional reservoir chamber is conducted to the writing tip via the fluid outlet and the connecting sleeve or its inlet to supply the writing fluid to the writing tip continually.

The first reservoir chamber and/or the at least one additional reservoir chamber comprises a notch or stopper at the connection connecting with the connecting sleeve to fit with a stopper or notch disposed on the connecting sleeve for limiting relative rotation between the first and at least one additional reservoir chambers and the connecting sleeve to communicate the fluid outlet of the at least one additional reservoir chamber with the inlet of the connecting sleeve in turn such that the writing fluid of the at least one additional reservoir chamber is conducted to the writing tip via the fluid outlet and the connecting sleeve or its inlet to supply the writing fluid to the writing tip continually.

The first reservoir chamber comprises a stopper or stopping channel to fit with a stopping channel or stopper disposed between the first reservoir chamber and the at least one additional reservoir chamber adjacent the first reservoir chamber or between the at least one additional reservoir chamber and the at least one additional reservoir chamber for limiting relative rotation between the at least one additional reservoir chamber and the connecting sleeve to communicate the fluid outlet of the at least one additional reservoir chamber with the fluid inlet of the first reservoir chamber in turn such that the writing fluid of the at least one additional reservoir chamber is conducted to the writing tip via the fluid outlet and the fluid inlet of the first reservoir chamber to supply the writing fluid to the writing tip continually.

The first reservoir chamber comprises a notch or stopper to fit with a stopper or notch disposed between the first reservoir chamber and the at least one additional reservoir chamber adjacent the first reservoir chamber or between the at least one additional reservoir chamber and the at least one additional reservoir chamber for limiting relative rotation between the at least one additional reservoir chamber and the connecting sleeve to communicate the fluid outlet of the at least one additional reservoir chamber with the fluid inlet of the first reservoir chamber in turn such that the writing fluid of the at least one additional reservoir chamber is conducted to the writing tip via the fluid outlet and the fluid inlet of the first reservoir chamber to supply the writing fluid to the writing tip continually.

The first reservoir chamber, the at least one additional reservoir chamber and the connecting sleeve comprise marks for aligning.

The invention switches the chambers by way of relative rotation for refilling the writing fluid and eliminating the leakage due to the pressure and attractive force generated by internal shock or longitudinal movement of the reservoir chambers in the prior art. The writing instrument of the present invention has the advantages of simple structure, low cast and long working life.

### BRIEF DESCRIPTION OF THE DRAWINGS

FIG. 1 is a schematic cross-section of the writing instrument according to the first embodiment of the present invention;

FIG. 2 is a cross-section taken along A-A of FIG. 1;

FIG. 3 is a cross-section taken along B-B of FIG. 1;

FIG. 4 is an exploded view showing the first and additional reservoir chambers and connecting sleeve of FIG. 1 in connecting status, the top is a partial schematic diagram of the reservoir chambers, and the below is a partial schematic view of the connecting sleeve;

FIG. 5 is a partial cross-section showing the connection of the reservoir chambers and the connecting sleeve;

FIG. 6 is an exploded view showing the first and additional reservoir chambers and connecting sleeve of FIG. 1 in connecting status according to another embodiment, the top is a partial schematic diagram of the reservoir chambers, and the below is a partial schematic view of the connecting sleeve;

FIG. 7 is a schematic cross-section of the writing instrument according to the second embodiment of the present invention;

FIG. 8 is a schematic diagram of the writing instrument of FIG. 7 with a housing and a cap;

FIG. 9 is a schematic cross-section of the writing instrument according to the third embodiment of the present invention;

FIG. 10 is a schematic cross-section of the writing instrument according to the fourth embodiment of the present invention;

FIG. 11 is a schematic cross-section of the writing instrument according to the fifth embodiment of the present invention;

FIG. 12 is an external view of FIG. 11;

FIG. 13 is an exploded view showing the additional reservoir chambers and the first reservoir chamber of FIG. 11 in connecting status, the top is a partial schematic diagram of the additional reservoir chamber, and the below is a partial schematic view of the first reservoir chamber;

FIG. 14 is a schematic cross-section of the writing instrument according to the sixth embodiment of the present invention;

FIG. 15 is a schematic view showing the flow of the air in the second fluid inlet of the fiber fluid core at the time of the fluid outlet of the first reservoir chamber rotating 180°;

FIG. 16 is a schematic diagram of the writing instrument of FIG. 14 with a housing and a cap;

FIG. 17 is an schematic exploded view of the first reservoir chamber and additional reservoir chamber of FIG. 14 in connecting status, the top is a partial diagram of the additional reservoir chamber, and the bottom is a partial diagram of the first reservoir chamber;

FIG. 18 is a schematic cross-section of the writing instrument according to the seventh embodiment of the present invention;

FIG. 19 is a schematic cross-section of the writing instrument according to the eighth embodiment of the present invention;

FIG. 20 is a cross-section taken along F-F of FIG. 19;

FIG. 21 is a schematic cross-section of the writing instrument according to the ninth embodiment of the present invention;

FIG. 22 is a schematic cross-section of the writing instrument according to the tenth embodiment of the present invention;

FIG. 23 is a schematic cross-section of the writing instrument according to the eleventh embodiment of the present invention; and

FIG. 24 is a schematic cross-section of the writing instrument according to the twelfth embodiment of the present invention.

1—writing tip, 11—ball, 12—ball sleeve, 13—conducting fluid core, 14—conducting fluid core sleeve, 15—leakproof device, 2—first reservoir chamber, 21, 22—additional reservoir chamber, 211—top portion, 212—bottom portion, 213—center shaft, 214—chamber casing, 201, 201′, 201″—fluid outlet, 202, 202′—fluid inlet, 24, 24′—fiber fluid core, 241—second fluid inlet, 242, 242′—second fluid outlet, 243, 243′—fiber fluid core sleeve, 244, 244′—exhaust outlet, 245—second conducting fluid core, 25, 25′—flange, 26, 26′—recess, 27, 27′—stopper, 28—notch, 29—partition, 3—connecting sleeve, 31, 31′—inlet, 32, 32′—seal ring, 35, 35′—stopping channel, 36—stopper, 37, 37′—vent, 38, 38′381, 381′—mark, 4, 4′—seal washer, 41, 41′—opening, 5, 51—writing fluid, 6—occlusion, 7—housing, 71—second vent, 8—cap.

### DEATILED DESCRPTION OF THE INVENTION

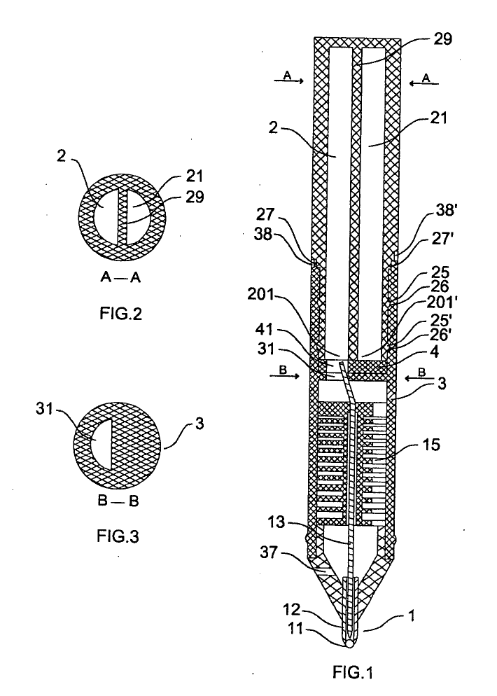

The present invention provides a writing instrument comprising: a writing tip 1 for applying writing fluid against the surface of written media, a first reservoir chamber 2 having a fluid outlet 201 for supplying the writing tip 1 with writhing fluid, a connecting sleeve 3 for connecting the writing tip 1 and the first reservoir chamber 2, and at least one additional reservoir chamber disposed the inside or outside of the first reservoir chamber 2. Referring to FIGS. 1 and 2, an additional reservoir chamber 21 is arranged outside of the first reservoir chamber 2. The additional reservoir chamber 21 comprises a fluid outlet 201. With relative rotation between the fluid outlet 201 of the additional reservoir chamber 21 and the connection sleeve 3, the writing fluid in the at least one additional reservoir chamber is conducted to the writing tip 1 via the fluid outlet 201′ to supply the writing fluid to the writing tip 1 continually. The present invention provides a writing instrument supplying the writing fluid continually by way of relative rotation. The present invention has good structure and low cost, eliminates the problems of dropping and leaking of the traditional writing instruments and provides a writing instrument with high volume of writing fluid, leakproof and long working life.

The additional reservoir chamber 21 is arranged outside of the first reservoir chamber 2. The first reservoir chamber 2 and the additional reservoir chamber 21 are in transverse arrangement in the direction of the length of the writing instrument.

Referring to FIGS. 1 and 2, in order to obtain a more reasonable transverse arrangement, a partition 29 is placed in a barrel to divide the barrel into the first reservoir chamber 2 and the additional reservoir chamber 21. The connecting sleeve 3 comprises an inlet 31. The inlet 31 of the connecting sleeve 3 is configured preferably to have eccentric structure (seeing FIG. 3). The fluid outlet 201 of the first reservoir chamber 2 communicates with the inlet 31 of the connecting sleeve 3 such that the writing fluid of the first reservoir chamber 2 is conducted to the conducting fluid core 13 of the writing tip 1 via the inlet 31, and then, the conducting fluid core 13 leads the writing fluid to a conventional ball tip for writing. A traditional leakproof device 15 is disposed above the writing tip 1 to prevent the writing fluid from dropping and leaking due to the pressure applied to the writing tip 1 by the writing fluid of the first reservoir chamber 2 with traditional low volume under variations of atmosphere and temperature.

When the writing fluid of the first reservoir chamber 2 is used up or remains a little, rotate the first reservoir chamber 2 and the additional reservoir chamber 21. With the relative rotation between the fluid outlet 201 of the additional reservoir chamber 21 and the connecting sleeve 3, the fluid outlet 201′ of the additional reservoir chamber 21 aligns and communicates with the inlet 31 of the connecting sleeve 3 such that the writing fluid of the additional reservoir chamber 21 is conducted to the writing tip 1 via the fluid outlet 201′ and the inlet 31 of the connecting sleeve 3 to supply continually the writing fluid to the writing tip 1. In the meantime, the fluid outlet 201 of the rotated first reservoir chamber 2 is sealed by a plate adjacent to the inlet 31 in the eccentric structure of the connecting sleeve 3, seeing the schematic view of the inlet 31 in the schematic shown in FIG. 3, such that the fluid outlet 201 of the first reservoir chamber 2 is closed. Thus, whatever atmosphere or temperature varies, it is impossible for the expanded air of the first reservoir chamber 2 to generate pressure and cause leakage against the writing fluid in the additional reservoir chamber 21 or the writing tip 1. In this way, the volume of the instrument is increased at least 1 time compare to the existing writing instruments, and without leakage. Switching of the chambers by way of rotation eliminates the leakage due to the pressure and attractive force generated by internal shock or longitudinal movement of the reservoir chambers in the prior art. The writing instrument of the present invention has the advantages of simple structure, low cast and long working life.

Furthermore, a seal washer 4 is disposed between the first and additional reservoir chambers 2 and 21 and the connecting sleeve 3. The seal washer 4 may be provided with an opening 41 communicating with the inlet 31 of the connecting sleeve 3, and in such case, the seal washer 4 and the connecting sleeve 3 may be fixed together. The seal washer 4 may be provided with two openings 41 communicating with the fluid outlets 201 and 201′ of the first and additional reservoir chambers 2 and 21, and in such case, the seal washer 4 may be fixed to the first and additional reservoir chambers 2 and 21 such that the first and additional reservoir chambers 2 and 21 is rotatably connected to the connecting sleeve 3 without leakage. The seal washer 4 may be formed with rubber, soft plastics, or resilient soft material, etc.

Referring to FIG. 1, two flanges 25 and 25′ are disposed at the connection between the first and additional reservoir chambers 2 and 21 and the connecting sleeve 3. Recesses 26 and 26′ are disposed at the connection between the connecting sleeve 3 and the first and additional reservoir chambers 2 and 21 to fit with the flanges 25 and 25′. In this way, the first and additional reservoir chambers 2 and 21 are stably fit with the connecting sleeve 3, and would not fall off when they rotatably connect with each other.

For the structure of two reservoir chambers, rotating 180° allows the fluid outlet 201′ of the additional reservoir chambers 21 to align and communicate with the inlet 31 of the connecting sleeve 3 so that the writing fluid of the additional reservoir chamber 21 is supplied continually to the writing tip 1 via the fluid outlet 201′ and the inlet 31 of the connecting sleeve 3.

In order to facilitate aligning the fluid outlet 201′ of the additional reservoir chamber 21 to the inlet 31 of the connecting sleeve 3, a mark 38′ is formed on the surface of the additional reservoir chamber 21 at the connection connecting with the connecting sleeve 3. The mark 38′ may be a graduation, or a colored dot or line, or a groove, or the like. A mark 38 is formed on the surface of the connecting sleeve 3 at the connection connecting with the first reservoir chamber 2. The mark 38 may be a graduation, or a colored dot or line, or a groove, or the like. In this way, after the writing fluid of the first reservoir chamber 2 is used up, with rotating 180° to allow the mark 38 to align the mark 38′, the fluid outlet 201′ of the additional reservoir chamber 21 aligns the inlet 31 of the connecting sleeve 3 such that the writing fluid of the additional reservoir chamber 21 is supplied continually to the writing tip 1 via the fluid outlet 201′ and the inlet 31.

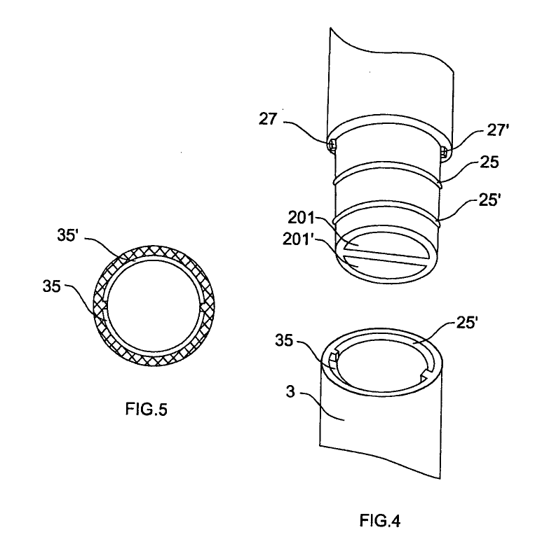

Referring to FIGS. 1 and 4, two stopper 27 and 27′ are disposed at the root of the connection between the first and additional reservoir chambers 2 and 21 and the connecting sleeve 3. The two stoppers 27 and 27′ are preferably located in the positions opposite to each other in 180°. Referring to FIGS. 4 and 5, two stopping channels 35 and 35′ are disposed at the opening portion of the connecting sleeve 3 to fit with the two stoppers 27 and 27′. The two stopping channels 35 and 35′ are preferably in about 170°. When the fluid outlet 201 of the first reservoir chamber 2 aligns the inlet 31 of the connecting sleeve 3, the two stoppers 27 and 27′ substantially stop at one end of the respective stopping channels. When it needs to align the fluid outlet 201′ of the additional reservoir chamber 21 to the inlet 31 of the connecting sleeve 3, rotate the connecting sleeve 3 or the first and additional reservoir chambers 2 and 21 until they cannot be rotated. In another word, when the stoppers are rotated to another end of the respective stopping channels 35 and 35′, it means that the fluid outlet 201′ of the additional reservoir chamber 21 has aligned the inlet 31 of the connecting sleeve 3 such that the writing fluid of the additional reservoir chamber 21 is supplied continually to the writing tip 1. Such structure is simple, reasonable and easy to use. The stopper and the stopping channel may be formed at the middle portion of the connection. For an embodiment having a stopping channel 35 formed at the opening portion of the connecting sleeve, the stopping channel 35 is in about 90°-270°. The stopper(s) on the first and additional reservoir chambers 2 and 21 and the stopping channel(s) on the connecting sleeve may be interchanged.

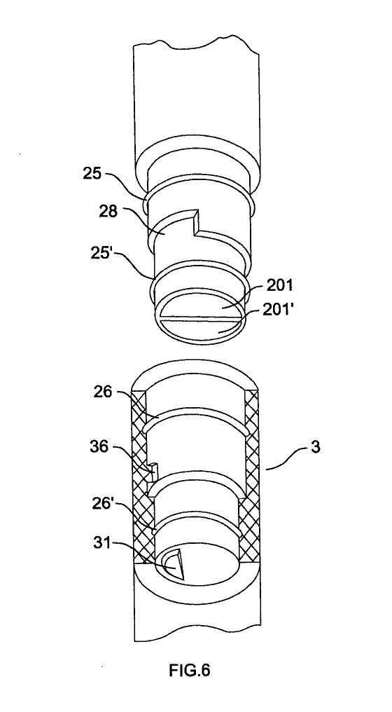

Referring to FIG. 6, a notch 28 is disposed at the connection of the first and additional reservoir chambers 2 and 21 and the connecting sleeve 3. The notch 28 is about 90°-270°, preferably 160°-200°. A stopper 36 is disposed on the connecting sleeve 3 to fit with the notch 28. When the fluid outlet 201 of the first reservoir chamber 2 aligns the inlet 31 of the connecting sleeve 3, the stopper 36 stops at one end of the notch 28. When it needs to align the fluid outlet 201′ of the additional reservoir chamber 21 and the inlet 31 of the connecting sleeve 3, rotate the connecting sleeve 3 or the first and additional reservoir chambers 2 and 21 untill they cannot be rotated. In another word, when the stopper is rotated to another end of the notch 28, the fluid outlet 201′ of the additional reservoir chamber 21 has aligned the inlet 31 of the connecting sleeve 3. Such structure is quite simple, reasonable and easy to use. The notch on the first and additional reservoir chambers 2 and 21 and the stopper on the connecting sleeve may be interchanged.

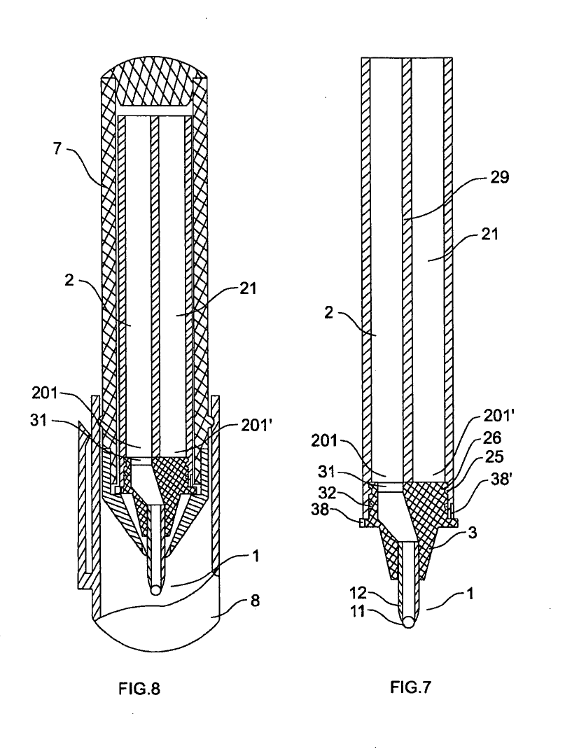

Referring to FIG. 7, in this embodiment, the reservoir chambers are opened and adapted for natural or oil ink used as the writing fluid. The additional reservoir chamber 21 disposed outside of the first reservoir chamber 2 and the first reservoir chamber 2 are in transverse arrangement in the length direction of the writing instrument. A connecting sleeve 3 is arranged between the first and additional reservoir chambers 2 and 21 and the writing tip 1. The first and additional reservoir chambers 2 and 21 and the connecting sleeve 3 rotatably connect each other. The connecting sleeve 3 is provided with an eccentric inlet 31 communicating with the fluid outlet 201 of the first reservoir chamber 2. When the writing fluid of the first reservoir chamber 2 remains a littler, rotating the first and additional reservoir chambers 2 and 21 relative to the connecting sleeve 3 allows the fluid outlet 201′ of the additional reservoir chamber 21 to align the eccentric inlet 31 of the connecting sleeve 3 such that the remained writing fluid in the connecting sleeve 3 butts the writing fluid of the additional reservoir chamber 21 to double the writing time of the writing tip 1.

A seal washer 32 is disposed at the connection between the first and additional reservoir chambers 2 and 21 and the connecting sleeve 3 to prevent leakage at the connection therebetween.

A flange 25 is formed at the connection between the first and additional reservoir chambers 2 and 21 and the connecting sleeve 3. A recess 26 is formed at the connection of the connecting sleeve 3 and the flange 33 to rotatably connect the first and additional reservoir chambers 2 and 21 to the connecting sleeve 3 and prevent leakage at the connection therebetween.

Referring to FIG. 8, it shows the writing instrument of FIG. 7 with a housing 7 and a cap 8 to protect the writing instrument and alternative writing instruments.

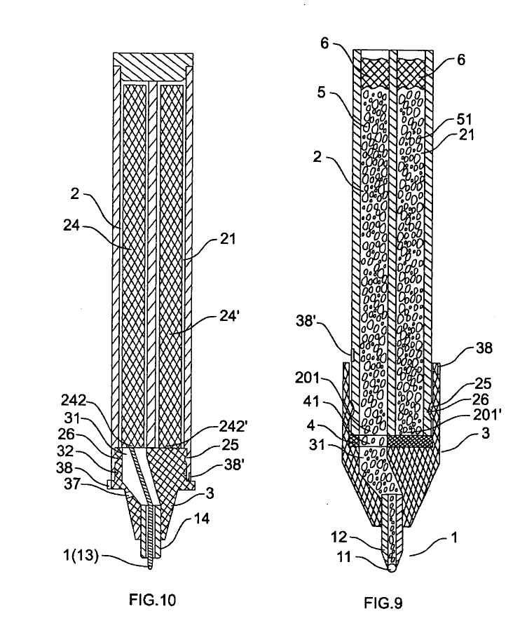

Referring to FIG. 9, the connecting sleeve 3 covers partially the fluid outlets 201 and 201′ of the first and additional reservoir chambers 2 and 21, as shown in figures, and the writing fluid 5 of the first reservoir chamber 2 is conducted to the writing tip 1 while the writing fluid 51 of the additional reservoir chamber 21 is sealed above the plate of the seal washer 4, i.e., above the plate adjacent the eccentric opening 21 of the seal washer 4 to prevent the writing fluid from dropping and leaking due to the pressure applied to the writing tip 1 by the writing fluid of the additional reservoir chamber 21. The writing fluid 5 and 51 may be in different colors so as to write different colors according to requirements.

An occlusion 6 is placed on the top opening portion of the writing fluid 5 and 51 of the opened first and additional reservoir chambers 2 and 21 to protect the writing fluid 5 and 51. The occlusion 6 may be occluding paste or occluding oil, etc.

Referring to FIG. 10, it is provided with fiber fluid cores based on the technical solution of FIG. 7. The fiber fluid core 24 is positioned in the first reservoir chamber 2 to allow the writing fluid of the first reservoir chamber 2 to be absorbed in the fiber fluid core 24, and the fiber fluid core 24′ is also positioned in the additional reservoir chamber 21 adjacent the first reservoir chamber 2 to allow the writing fluid of the additional reservoir chamber 21 to be absorbed in the fiber fluid core 24′. A conducting fluid core 13 which may be used for writing is connected with the second fluid outlet 242 of the fiber fluid core 24 of the first reservoir chamber 2. Such structure can be used as a refill.

A writing instrument comprises three reservoir chambers. A first reservoir chamber and two additional reservoir chambers are arranged in a barrel. The fluid outlet of the first reservoir chamber may have the structure as the same as the structure communicating with the inlet of the connecting sleeve, for example, in FIG. 1, and the two additional reservoir chambers are sealed with a place adjacent the eccentric inlet of the connecting sleeve. When the writing fluid of the first reservoir chamber is used up, rotating the two additional reservoir chambers in turn will allow the fluid outlets thereof to communicate the inlet of the connecting sleeve in turn such that the writing instrument possesses the effect of multiply and continually writing.

A writing instrument according to the present invention may comprise a first reservoir chamber and three additional reservoir chambers. A circular or square barrel may be divided into four reservoir chambers in order to have the reasonable arrangement for the four reservoir chambers.

At least one additional reservoir chamber disposed outside of the first reservoir chamber and the first reservoir chamber is in end-to-end arrangement in the direction of the length of the writing instrument. The at least one additional reservoir chamber is located above the first reservoir chamber. Please refer to the following examples.

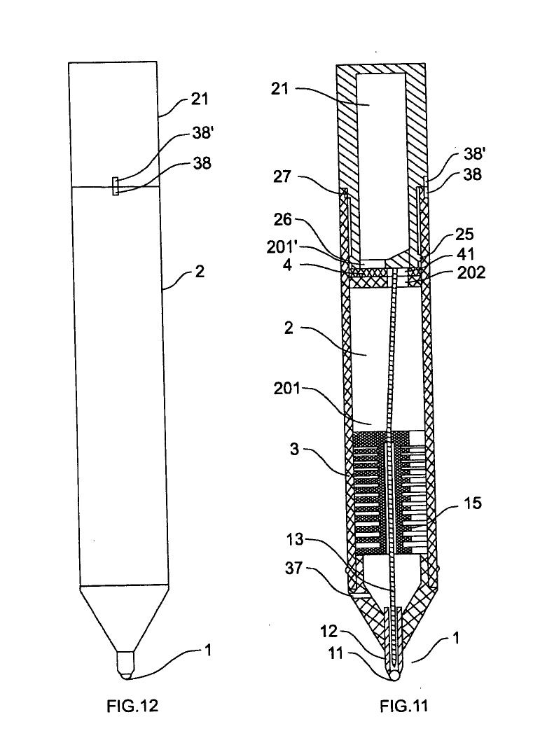

Referring to FIGS. 11 and 12, an additional reservoir chamber 21 is positioned above the first reservoir chamber 2. The additional reservoir chamber 21 may rotate with respect of the connecting sleeve 3. The connecting sleeve 3 may be configured to integrate with the first reservoir chamber 2. In this way, the additional reservoir chamber 21 may also rotate with respect of the first reservoir chamber 2. A fluid inlet 202 is formed at the top portion of the first reservoir chamber 2, and a fluid outlet 201′ is formed at the bottom portion of the additional reservoir chamber 21. When the writing fluid of the first reservoir chamber 2 is used up or remains a litter, with rotating the additional reservoir chamber in 180°, the fluid outlet 201′ of the additional reservoir chamber 21 communicates with the fluid inlet 202 of the first reservoir chamber 2. In this way, the writing fluid of the additional reservoir chamber 21 flows into the first reservoir chamber 2 via the fluid outlet 201′ and fluid inlet 202 such that the writing tip 1 may be supplied with the writing fluid again for continually writing. Then, with rotating the additional reservoir chamber in 180° continually, the fluid outlet 201′ of the additional reservoir chamber 21 returns to its original position (it has rotated in 360°), seeing FIGS. 11 and 12, and the marks 38 and 38′ align each other again. In this way, the eccentric fluid outlet 201′ of the additional reservoir chamber 21 is sealed again with a plate adjacent to the first reservoir chamber 2. In another word, it is sealed with the plate adjacent to the eccentric fluid inlet 202 to close the air in the empty additional reservoir chamber 21. Whenever atmosphere or temperature varies, it is impossible for the expanded air of the additional reservoir chamber 21 to generate pressure applying to the writing fluid in the first reservoir chamber 2. In another word, the first reservoir chamber 2 refilled with the writing fluid may also regularly provide the writing fluid to the writing tip 1 without any leakage. Such writing instrument has the structure with large volume for writing fluid, without leakage and increases its working life.

Furthermore, a seal washer 4 is disposed between the first reservoir chamber 2 and additional reservoir chamber 21. The seal washer 4 may be provided with an opening 41 communicating with the fluid inlet 202 of the first reservoir chamber 2, and in such case, the seal washer 4 and the first reservoir chamber 2 may be fixed together. The seal washer 4 may be provided with an opening 41 communicating with the fluid outlet 201′ of the additional reservoir chamber 21, and in such case, the seal washer 4 and the additional reservoir chamber 21 may be fixed together such that the first reservoir chamber 2 and the additional reservoir chamber 21 rotatably connect with each other without leakage.

A conducting fluid core 13 in the writing tip 1 may extend into the opening 41 of the seal washer 4. When the fluid outlet 201′ of the additional reservoir chamber 21 aligns the opening 41, the conducting fluid core 13 may conduct the writing fluid of the additional reservoir chamber 21 to the first reservoir chamber 2 quickly.

A recess 26 is formed at the connection of the first reservoir chamber 2 and the additional reservoir chamber 21, and a flange 25 is formed at the connection of the additional reservoir chamber 21 and the first reservoir chamber 2 to fit with the recess 26 such that the first reservoir chamber 2 and the additional reservoir chamber 21 rotatably connect and stably lock with each other and would not fall off. The recess 26 on the first reservoir chamber 2 and the flange 25 on the additional reservoir chamber 21 may be interchanged.

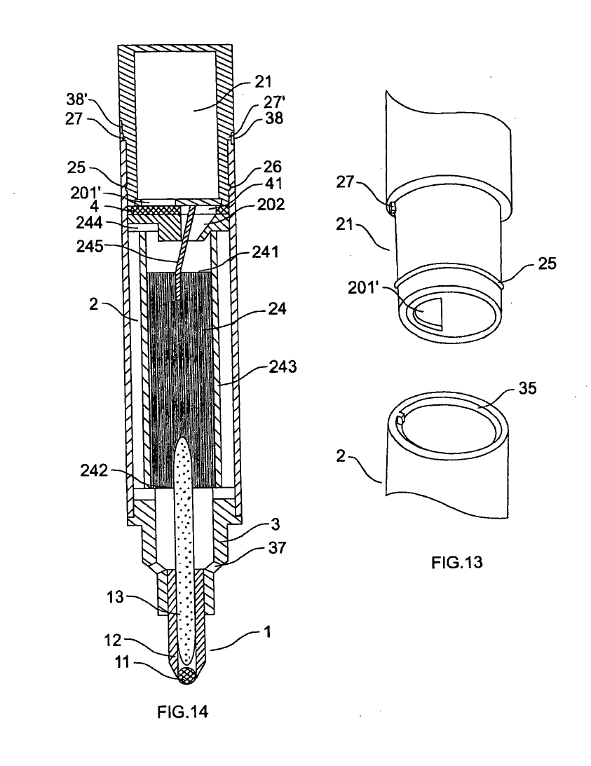

Referring to FIGS. 11 and 13, a stopper 27 is arranged at the root of the connection between the additional reservoir chamber 21 and the first reservoir chamber 2. A stopping channel 35 is arranged at the opening portion of connection of the first reservoir chamber 2 and the additional reservoir chamber 21 to fit with the stopper 27. The stopping channel 35 is in about 350°. When the fluid outlet 201′ of the additional reservoir chamber 2 is sealed with the plate adjacent to the eccentric fluid inlet 202 of the first reservoir chamber 2, the stopper 27 substantially stops at one end of the stopping channel 35. When it need to align the fluid outlet 201′ of the additional reservoir chamber 21 and the fluid inlet 202 of the first reservoir chamber 2, with rotating the additional reservoir chamber 21 in 180°, the fluid outlet 201′ aligns and communicates with the fluid inlet 202 such that the writing fluid of the additional reservoir chamber 21 flows into the first reservoir chamber 2 to supply continually the writing fluid to the writing tip 1. Next, with rotating continually the additional reservoir chamber 21 until it cannot be rotated, the fluid outlet 201′ and the fluid inlet 202 stagger and are sealed to prevent the leakage due to the pressure against the first reservoir chamber 2 with the air of the empty additional reservoir chamber 21. Such structure is quite simple, reasonable, and easy for use.

A notch or stopper may be formed on the additional reservoir chamber 21, and a stopper or notch may be formed on the first reservoir chamber 2 to fit with the notch or stopper of the additional reservoir chamber 21. Its description is similar to the one of FIG. 6. Please refer to above for details.

Referring to FIG. 14, an additional reservoir chamber 21 is arranged above the first reservoir chamber 2. The additional reservoir chamber 21 and the connecting sleeve 3 may rotate relatively. In another word, the fluid outlet 201′ may rotate with respect to the connecting sleeve 3. In the embodiment, there is a fiber fluid core 24 arranged in the first reservoir chamber 2 of FIG. 11 to allow the writing fluid of the first reservoir chamber 2 to be absorbed in the fiber fluid cores 24. The fiber fluid core 24 may be formed from natural plant fiber, or chemical fiber, or the like. The fiber fluid core 24 may be positioned in a fiber fluid core sleeve 243 convenient to manufacture and assemble. The second fluid outlet 242 of the fiber fluid core 24 butts the conducting fluid core 13 of the writing tip 1 such that the writing fluid of the fiber fluid core 24 of the first reservoir chamber 2 is supplied to the ball 11 of the writing tip 1 via the conducting fluid core 13. When the writing fluid of the fiber fluid core 24 of the first reservoir chamber 2 is used up or remains a little, with rotating the additional reservoir chamber in 180° relative to the connecting sleeve 3, the mark 38′ of the additional reservoir chamber 21 aligns the mark 38 of the first reservoir chamber 2. In this way, the writing fluid of the additional reservoir chamber 21 flows into the fiber fluid core 24 of the first reservoir chamber 2 via the fluid outlet 201′, the opening 41 of the seal washer 4 and the fluid inlet 202 of the first reservoir chamber 2 to allow the refilled writing fluid in the first reservoir chamber 2 to be absorbed in the fiber fluid core 24 such that the writing tip 1 may be supplied with the writing fluid again for continually writing. For the structure of the fiber fluid core 24 used in the first reservoir chamber 2 for absorbing the writing fluid, a conventional leakproof device between the writing tip 1 and the first reservoir chamber 2 may be omitted.

Referring to FIGS. 14 and 15, an exhaust outlet 244 is formed between the second fluid inlet 241 of the fiber fluid core 24 and the fluid inlet 202, or on the second fluid outlet 242. A vent 37 is formed in the first reservoir chamber 2 or the connecting sleeve 3 to communicate with the exhaust outlet 37. Such structure has advantages: 1. When the writing fluid of the additional reservoir chamber 21 flows into the second fluid inlet 241 of the fiber fluid core 24 via the fluid outlet 201′, the air in the fiber fluid core 24 is discharged towards the exhaust outlet 244 to leave space for the writing fluid. In this way, the writing fluid of the additional reservoir chamber 21 flows into the fiber fluid core 24 smoothly and leakage is eliminated; 2. When atmosphere and temperature vary, the expanded air in the additional reservoir chamber 21 or the expanded air in the first reservoir chamber 2 may be discharged from the exhaust outlet 244 and the vent 37 to the outside of the writing instrument. Thus, leakage is eliminated.

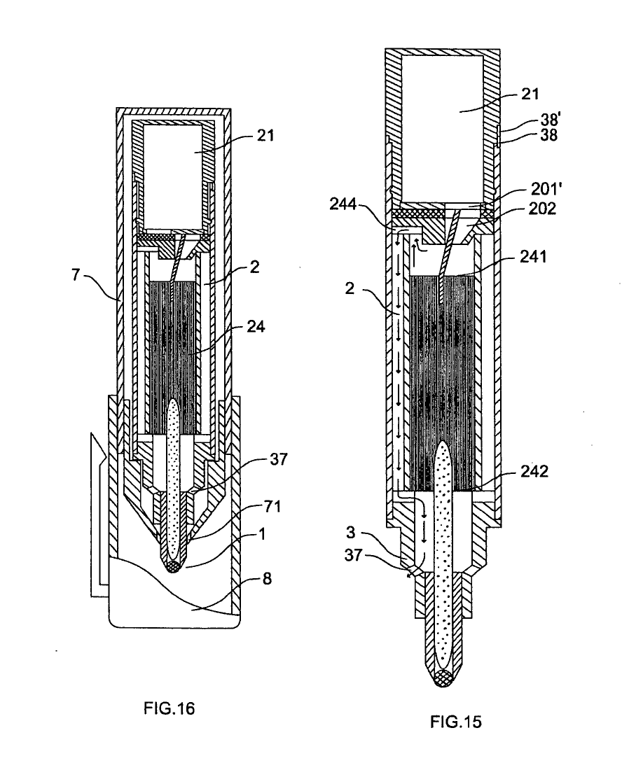

FIG. 16 shows the structure of FIG. 14 with a housing 7 for enhancing the strength of the writing instrument and facilitating writing. A second vent 71 is formed on the housing 7. The second vent 71 communicates with the vent 37 to discharge the air from the vent 37 via the second vent 71 to the outside of the housing 7. A cap 8 covers the head of the writing tip 1 to protect the writing tip 1 from collision and prevent the writing fluid from dirtying things.

Referring to FIGS. 14 and 17, two stoppers 27, 27′ are disposed at the root of the connection between the additional reservoir chamber 21 and the first reservoir chamber 2. The two stoppers 27, 27′ are preferably located in positions opposite to each other in 180°. Two stopping channels 35 and 35′ are formed at the opening portion of the connection between the first reservoir chamber 2 and the additional reservoir chamber 21 to fit with the two stoppers 27, 27′. The two stopping channels 35, 35′ are preferably in about 170°. When the fluid outlet 201′ of the additional reservoir chamber 21 is sealed with the plate adjacent the eccentric fluid inlet 202 of the first reservoir chamber 2, the two stoppers 27, 27′ substantially stop at one end of the respective stopping channels 35, 35′. When it needs to align the fluid outlet 201′ of the additional reservoir chamber 21 to the fluid inlet 202 of the first reservoir chamber 2, with rotating the additional reservoir chamber 21 untill it cannot be rotated, the fluid outlet 201′ of the additional reservoir chamber 21 aligns the fluid inlet 202 of the first reservoir chamber 2 such that the writing fluid of the additional reservoir chamber 21 is supplied continually to the writing tip 1. Such structure is simple, reasonable and easy to use. For an embodiment having a stopping channel 35 formed at the opening portion of the additional reservoir chamber 21, the stopping channel 35 may be in about 90°-270° in circumferencial direction. The stopper(s) on the additional reservoir chamber 21 and the stopping channel(s) on the first reservoir chamber 2 may be interchanged.

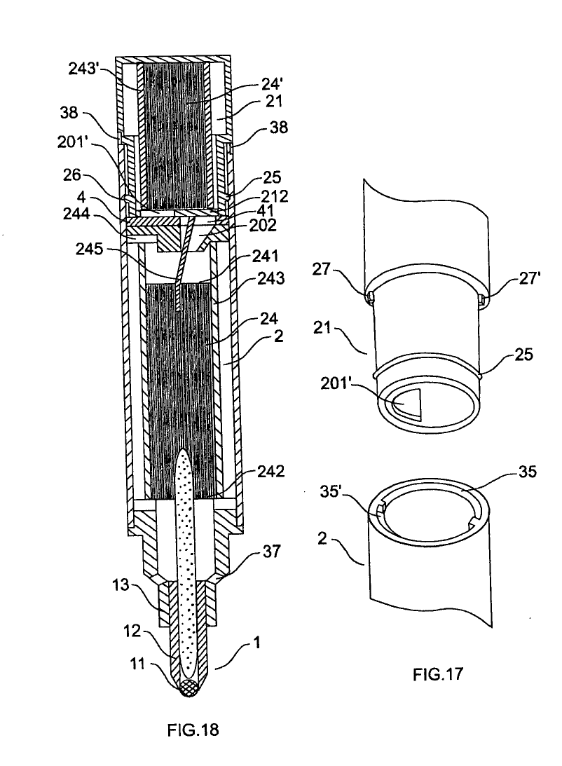

FIG. 18, a fiber fluid core 24′ is also disposed in the additional reservoir chamber 21 to allow the writing fluid of the additional reservoir chamber 21 to be absorbed in the fiber fluid cores 24′. A second fluid inlet 241 is disposed on the fiber fluid core 24′ and a second conducting fluid core 245 is disposed in the second fluid inlet 241. The second conducting fluid core 245 extends to the bottom 212 of the additional reservoir chamber 21. When the additional reservoir chamber 21 is rotated to align the fluid outlet 201′ to the opening 41 of the seal washer 4, the second conducting fluid core 245 of the fiber fluid core 24 and the fiber fluid core 24′ of the additional reservoir chamber 21 contact with each other such that the writing fluid in the fiber fluid core 24′ is conducted into the fiber fluid core 24 via the second conducting fluid core 245 to supply the writing fluid to the writing tip 1 continually.

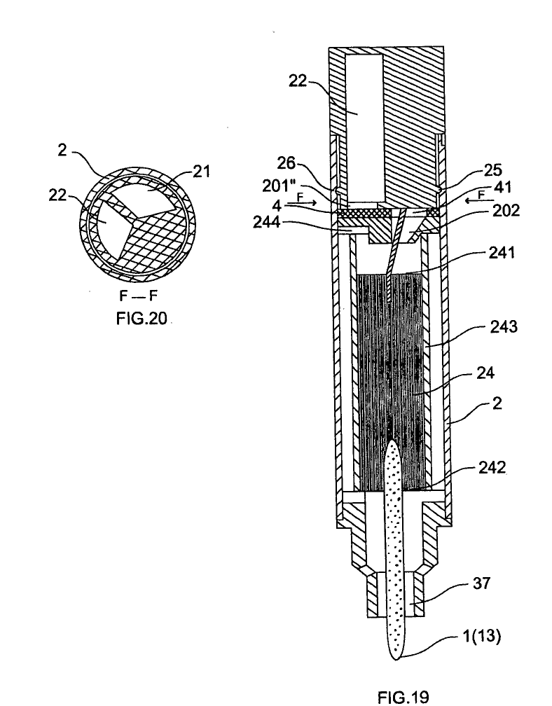

Referring to FIGS. 19 and 20, two additional reservoir chambers 21, 22 are arranged side-by-side above the first reservoir chamber 2. When the writing fluid of the first reservoir chamber 2 is used up or remains a little, with rotating the fluid outlets of the additional reservoir chambers 21, 22 in turn to communicate with the fluid inlet 202 of the first reservoir chamber 2, the writing instrument obtains the writing fluid for writing continually many times. FIG. 20 is a cross-section taken along F-F of FIG. 19. FIG. 19 is a cross-section and does not show the additional reservoir chamber 21. The writing fluid in the present embodiment may be paint.

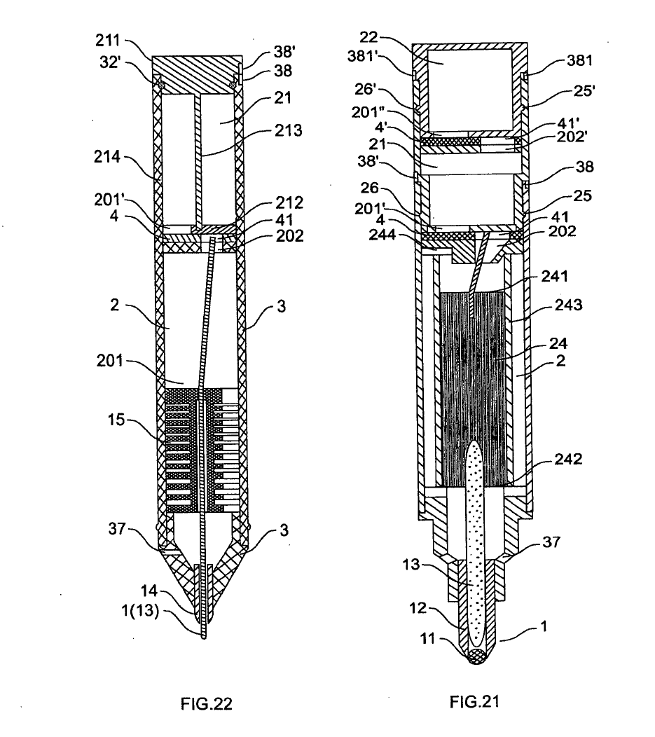

Referring to FIG. 21, the writing instrument may be also provided wtih an additional reservoir chamber 22 arranged above the additional reservoir chamber 21. A fluid inlet 202′ is formed at the top of the additional reservoir chamber 21, and a fluid outlet 201″ is formed at the bottom of the additional reservoir chamber 22. A seal washer 4′ is arranged between the fluid outlet 201″ and the fluid inlet 202′. The seal washer 4′ is provided with an opening 41′ communicating with the fluid inlet 202′. When the fluid outlet 201′ of the additional reservoir chamber 21 communicates with the fluid inlet 202 of the first reservoir chamber 2 and the writing fluid of the additional reservoir chamber 21 is used up, with rotating the additional reservoir chamber 22 with respect to the connecting sleeve 3, the fluid outlet 201″ of the additional reservoir chamber 22 communicates with the fluid inlet 202′. In this way, the writing fluid of the additional reservoir chamber 22 flows into the fiber fluid core 24 of the first reservoir chamber 2 via the fluid inlet 202′ of the additional reservoir chamber 21, fluid outlet 201′ and the fluid inlet 202.

FIG. 22 is a modification of FIG. 11. In this embodiment, the top portion 211 and the bottom portion 212 of the additional reservoir chamber 21 are configured to rotatably connect with chamber casing 214. The top portion 211 and the bottom portion 212 interconnect with a center shaft 213 disposed in the middle therebetween. When rotate the top portion 211 of the additional reservoir chamber 21, with rotation of the fluid outlet 201′ of the bottom portion 212 driven by the center shaft 213, the fluid outlet 201′ of the additional reservoir chamber 21 and the connecting sleeve 3 rotate relatively such that the writing fluid of the additional reservoir chamber 21 flows into the first reservoir chamber 2 via fluid outlet 201′ and the fluid inlet 202 of the first reservoir chamber 2.

A seal ring 32′ is disposed between the top portion 211 and the chamber casing 214 to prevent leakage therebewteen.

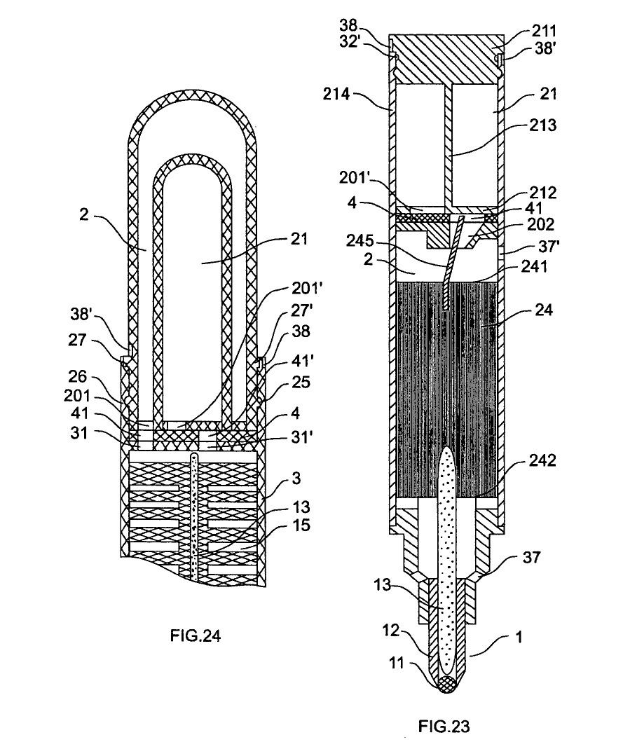

Referring to FIG. 23, in this embodiment, there is a fiber fluid core 24 arranged in the technical solution of FIG. 22. The fiber fluid core 24 is disposed in the first reservoir chamber 2 to allow the writing fluid of the first reservoir chamber 2 to be absorbed in the fiber fluid core 24. A vent 37′ is formed on the side wall of the first reservoir chamber 2 between the second fluid inlet 241 and the fluid inlet 202 to prevent the writing instrument from leaking under variations of atmosphere and temperature. Such structure may omit the conventional leakproof device.

The writing instruments according to the invention may be provided with at least one additional reservoir chamber disposed in the first reservoir chamber 2 and surrounding the first reservoir chamber. The details will be explained with exemplary embodiments as below.

Referring to FIG. 24, an additional reservoir chamber 21 is arranged in the first reservoir chamber 2. The first reservoir chamber 2 and the additional reservoir chamber 21 are rotatably connected with the connecting sleeve 3. The connecting sleeve 3 comprises two inlets 31, 31′. A seal washer 4 is disposed between the first and additional reservoir chambers 2 and 21 and the connecting sleeve 3 to prevent leakage theretween. The seal washer 4 is provided with two openings 41, 41′ communicating with the inlets 31, 31′ of the connecting sleeve 3. The seal washer 4 and the connecting sleeve 3 are fixed together, one of the inlets 31 communicates with the fluid outlet 201 of the first reservoir chamber 2 and another inlet 31′ does not communicate with the fluid outlet 201′ of the additional reservoir chamber 21 because they stagger each other. When the writing fluid of the first reservoir chamber 2 is used up, with rotating the first and additional reservoir chambers 2 and 21, the fluid outlet 201′ of the additional reservoir chamber 21 aligns the opening 41′ of the seal washer 4 such that the writing fluid of the additional reservoir chamber 21 is conducted to the writing tip 1 via the fluid outlet 201′, the opening 41 and the another inlet 31′ to supply the writing fluid to the writing tip 1 continually. In the meantime, the fluid outlet 201 of the first reservoir chamber 2 staggers the opening 41 of the seal washer 4 and is sealed with the plate of the seal washer after the rotation.

Referring to FIG. 1, the writing tip 1 may comprise the conducting fluid core 13 and a conventional ball head. The conventional ball head may comprise a ball 11 and a ball sleeve 12.

The writing tip 1 may be a conventional pen tip or a conducting fluid core disposed on the conventional pen tip. The writing tip 1 may also be a tip with gap, and in such structure, it is necessary to dispose the leakproof device as shown, for example, in FIG. 1 on the tip with gap.

Referring to FIG. 7, the writing tip 1 may be a conventional ball header. The conventional ball head may comprise a ball 11 and a ball sleeve 12.

Referring to FIG. 10, a conducting fluid core 13 for absorbing writing fluid and writing may be used as the writing tip 1. The conducting fluid core 13 is provided with a conducting fluid core sleeve 14 to enhance the strength of the conducting fluid core 13. Such writing tip can be used in a wide range. For examples, paper, walls, bags, floors, or boxes, etc. may be used as written media.

While the invention has been illustrated and described in detail in the drawings and foregoing description, such illustration and description is to be considered as exemplary and not restrictive in character, it being understood that only the preferred embodiment has been shown and described and that al changes and modifications that come within the spirit of the invention are described to be protected.

What is claimed is:

1. A writing instrument, the writing instrument comprising: a writing tip for spreading writing fluid on surface of written media, a first reservoir chamber having a fluid outlet for supplying the writing tip with writhing fluid, a connecting sleeve for connecting the writing tip and the first reservoir chamber, in characterized that said instrument further comprises at least one additional reservoir chamber inside or outside of the first reservoir chamber, wherein each additional reservoir chamber comprises a fluid outlet, and wherein, with relative rotation between the fluid outlet of the at least one additional reservoir chamber and the connecting sleeve, the writing fluid of the at least one additional reservoir chamber is conducted to the writing tip via the fluid outlet to supply the writing tip with the writing fluid continually.

2. The writing instrument of claim 1, wherein the at least one additional reservoir chamber outside of the first reservoir chamber and the first reservoir chamber are in transverse arrangement in (or along) the direction of the length of the writing instrument, and the connecting sleeve comprises an inlet, and wherein the first reservoir chamber and the at least one additional reservoir chamber are rotated, and with relative rotation between the fluid outlet of the at least one additional reservoir chamber and the connecting sleeve, the fluid outlet of the at least one additional reservoir chamber communicates with the inlet of the connecting sleeve in turn such that the writing fluid of the at least one additional reservoir chamber is conducted to the writing tip via the fluid outlet and the inlet of the connecting sleeve to supply writing fluid to the writing tip continually.

3. The writing instrument of claim 1, wherein the at least one additional reservoir chamber outside of the first reservoir chamber and the first reservoir chamber are in longitudinal arrangement in the direction of the length of the writing instrument, the at least one additional reservoir chamber is located above the first reservoir chamber, and the first reservoir chamber or the first and at least one additional reservoir chambers comprise fluid inlets at the top portions thereof, and wherein the chamber casing or the bottom portion of the at least one additional reservoir chamber is rotated, and with relative rotation between the fluid outlet of the at least one additional reservoir chamber and the connecting sleeve, the fluid outlet of the at least one additional reservoir chamber communicates with the fluid inlet of the first reservoir chamber in turn such that writing fluid of the at least one additional reservoir chamber flows into the first reservoir chamber via the fluid inlet of the first reservoir chamber in turn to supply the writing fluid to the writing tip continually.

4. The writing instrument of claim 3, further comprising a center shaft disposed in the at least one additional reservoir chamber and at the connection between the bottom portion and the top portion of the at least one additional reservoir chamber to allow the bottom portion of the at least one additional reservoir chamber to rotate such that the fluid outlet of the at least one additional reservoir chamber communicates with the fluid inlet of the first reservoir chamber in turn.

5. The writing instrument of claim 1, wherein the at least one additional reservoir chamber inside or outside the first reservoir chamber is disposed surrounding the first reservoir chamber, and the connecting sleeve comprises at least two inlets, one of them communicating with the first reservoir chamber, and wherein the first reservoir chamber and the at least one additional reservoir chamber rotate, and with relative rotation between the fluid outlet of the at least one additional reservoir chamber and the connecting sleeve, the fluid outlet of the at least one additional reservoir chamber communicates with another inlet of at least two inlets of the connecting sleeve in turn such that writing fluid of the at least one additional reservoir chamber is conducted to the writing tip via the fluid outlet and the another inlet of the connecting sleeve to supply the writing fluid to the writing tip continually.

6. The writing instrument of claim 1, further comprising a seal washer disposed between the first and at least one additional reservoir chambers and the connecting sleeve.

7. The writing instrument of claim 2, further comprising a seal washer disposed between the first and at least one additional reservoir chambers and the connecting sleeve.

8. The writing instrument of claim 5, further comprising a seal washer disposed between the first and at least one additional reservoir chambers and the connecting sleeve.

9. The writing instrument of claim 3, further comprising a seal washer disposed between the first and at least one additional reservoir chambers and the connecting sleeve.

10. The writing instrument of claim 1, further comprising a fiber fluid core arranged in the first reservoir chamber and/or the at least one additional reservoir chamber to allow the writing fluid of the first reservoir chamber and/or the at least one additional reservoir chamber to be absorbed in the fiber fluid core, wherein the fiber fluid core communicates with the writing tip via the fluid outlets of the first reservoir chamber and/or the at least one additional reservoir chamber.

11. The writing instrument of claim 2, further comprising a fiber fluid core arranged in the first reservoir chamber and/or the at least one additional reservoir chamber to allow the writing fluid of the first reservoir chamber and/or the at least one additional reservoir chamber to be absorbed in the fiber fluid core, wherein the fiber fluid core communicates with the writing tip via the fluid outlets of the first reservoir chamber and/or the at least one additional reservoir chamber.

12. The writing instrument of claim 3, further comprising a fiber fluid core arranged in the first reservoir chamber and/or the at least one additional reservoir chamber to allow the writing fluid of the first reservoir chamber and/or the at least one additional reservoir chamber to be absorbed in the fiber fluid core, wherein the fiber fluid core communicates with the writing tip via the fluid outlets of the first reservoir chamber and/or the at least one additional reservoir chamber.

13. The writing instrument of claim 5, further comprising a fiber fluid core arranged in the first reservoir chamber and/or the at least one additional reservoir chamber to allow the writing fluid of the first reservoir chamber and/or the at least one additional reservoir chamber to be absorbed in the fiber fluid core, wherein the fiber fluid core communicates with the writing tip via the fluid outlets of the first reservoir chamber and/or the at least one additional reservoir chamber.

14. The writing instrument of claim 1, wherein the writing tip is a conventional ball tip, pen tip, or a conducting fluid core for adsorbing writing fluid and writing, or the combinations thereof.

15. The writing instrument of claim 2, wherein the writing tip is a conventional ball tip, pen tip, or a conducting fluid core for adsorbing writing fluid and writing, or the combinations thereof.

16. The writing instrument of claim 3, wherein the writing tip is a conventional ball tip, pen tip, or a conducting fluid core for adsorbing writing fluid and writing, or the combinations thereof.

17. The writing instrument of claim 5, wherein the writing tip is a conventional ball tip, pen tip, or a conducting fluid core for adsorbing writing fluid and writing, or the combinations thereof.

18. The writing instrument of claim 1, wherein the first reservoir chamber and/or the at least one additional reservoir chamber comprises a stopper or stopping channel at the connection connecting with the connecting sleeve to fit with a stopping channel or stopper disposed on the connecting sleeve for limiting relative rotation between the first and at least one additional reservoir chambers and the connecting sleeve to communicate the fluid outlet of the at least one additional reservoir chamber with the inlet of the connecting sleeve in turn such that the writing fluid of the at least one additional reservoir chamber is conducted to the writing tip via the fluid outlet and the connecting sleeve to supply the writing fluid to the writing tip continually.

19. The writing instrument of claim 2, wherein the first reservoir chamber and/or the at least one additional reservoir chamber comprises a stopper or stopping channel at the connection connecting with the connecting sleeve to fit with a stopping channel or stopper disposed on the connecting sleeve for limiting relative rotation between the first and at least one additional reservoir chambers and the connecting sleeve to communicate the fluid outlet of the at least one additional reservoir chamber with the inlet of the connecting sleeve in turn such that the writing fluid of the at least one additional reservoir chamber is conducted to the writing tip via the fluid outlet and the inlet of the connecting sleeve to supply the writing fluid to the writing tip continually.

20. The writing instrument of claim 5, wherein the first reservoir chamber and/or the at least one additional reservoir chamber comprises a stopper or stopping channel at the connection connecting with the connecting sleeve to fit with a stopping channel or stopper disposed on the connecting sleeve for limiting relative rotation between the first and at least one additional reservoir chambers and the connecting sleeve to communicate the fluid outlet of the at least one additional reservoir chamber with the inlets of the connecting sleeve in turn such that the writing fluid of the at least one additional reservoir chamber is conducted to the writing tip via the fluid outlet and the inlets of the connecting sleeve to supply the writing fluid to the writing tip continually.

21. The writing instrument of claim 1, wherein the first reservoir chamber and/or the at least one additional reservoir chamber comprises a notch or stopper at the connection connecting with the connecting sleeve to fit with a stopper or notch disposed on the connecting sleeve for limiting relative rotation between the first and at least one additional reservoir chambers and the connecting sleeve to communicate the fluid outlet of the at least one additional reservoir chamber with the inlet of the connecting sleeve in turn such that the writing fluid of the at least one additional reservoir chamber is conducted to the writing tip via the fluid outlet and the connecting sleeve to supply the writing fluid to the writing tip continually.

22. The writing instrument of claim 2, wherein the first reservoir chamber and/or the at least one additional reservoir chamber comprises a notch or stopper at the connection connecting with the connecting sleeve to fit with a stopper or notch disposed on the connecting sleeve for limiting relative rotation between the first and at least one additional reservoir chambers and the connecting sleeve to communicate the fluid outlet of the at least one additional reservoir chamber with the inlet of the connecting sleeve in turn such that the writing fluid of the at least one additional reservoir chamber is conducted to the writing tip via the fluid outlet and the inlet of the connecting sleeve to supply the writing fluid to the writing tip continually.

23. The writing instrument of claim 5, wherein the first reservoir chamber and/or the at least one additional reservoir chamber comprises a notch or stopper at the connection connecting with the connecting sleeve to fit with a stopper or notch disposed on the connecting sleeve for limiting relative rotation between the first and at least one additional reservoir chambers and the connecting sleeve to communicate the fluid outlet of the at least one additional reservoir chamber with the inlets of the connecting sleeve in turn such that the writing fluid of the at least one additional reservoir chamber is conducted to the writing tip via the fluid outlet and the inlets of the connecting sleeve to supply the writing fluid to the writing tip continually.

24. The writing instrument of claim 3, wherein the first reservoir chamber comprises a stopper or stopping channel to fit with a stopping channel or stopper disposed between the first reservoir chamber and the at least one additional reservoir chamber adjacent the first reservoir chamber or between the at least one additional reservoir chamber and the at least one additional reservoir chamber for limiting relative rotation between the at least one additional reservoir chamber and the connecting sleeve to communicate the fluid outlet of the at least one additional reservoir chamber with the fluid inlet of the first reservoir chamber in turn such that the writing fluid of the at least one additional reservoir chamber is conducted to the writing tip via the fluid outlet and the fluid inlet of the first reservoir chamber to supply the writing fluid to the writing tip continually.

25. The writing instrument of claim 1, wherein the first reservoir chamber comprises a notch or stopper to fit with a stopper or notch disposed between the first reservoir chamber and the at least one additional reservoir chamber adjacent the first reservoir chamber or between the at least one additional reservoir chamber and the at least one additional reservoir chamber for limiting relative rotation between the at least one additional reservoir chamber and the connecting sleeve to communicate the fluid outlet of the at least one additional reservoir chamber with the fluid inlet of the first reservoir chamber in turn such that the writing fluid of the at least one additional reservoir chamber is conducted to the writing tip via the fluid outlet and the fluid inlet of the first reservoir chamber to supply the writing fluid to the writing tip continually.

26. The writing instrument of claim 1, in characterized that the first reservoir chamber, the at least one additional reservoir chamber and the connecting sleeve comprise marks for aligning.
